(19) United States
(12) Patent Application Publication
(10) Pub. No.: US 2011/0085920 A1
(43) Pub. Date: Apr. 14, 2011

(54) METHOD AND APPARATUS FOR DYNAMIC IMPULSE SIGNAL ATTENUATION SIMULATION

(76) Inventors: Sean Kelly Summers, Minden, NV (US); Roger Aloysius Hala, Gardnerville, NV (US); Brian Francis Howard, Issaquah, WA (US); David Russell Van Wagenen, Minden, NV (US)

(21) Appl. No.: 12/578,870

(22) Filed: Oct. 14, 2009

(51) Int. Cl. G01H 17/00; F04B 49/00; F04B 35/04

(52) U.S. Cl. 417/63; 417/415; 73/649

(57) ABSTRACT

A method of simulating attenuation of an impulse signal of a reciprocating compressor includes providing a reciprocating compressor that includes a crank connected to a motor, a compression chamber, a reciprocating piston positioned in the compression chamber, and a connecting rod attached to the piston. The method also includes connecting the connecting rod to the crank with a first crank pin, mounting at least one transducer on the reciprocating compressor, running the compressor, measuring a first impulse signal with the at least one transducer, replacing the first crank pin with a second crank pin, the second crank pin having a diameter different than the diameter of the first crank pin, running the compressor, measuring a second impulse signal with the at least one transducer, and comparing the first impulse signal to the second impulse to determine an amount of attenuation between the first and second impulse signals.

### BACKGROUND OF THE INVENTION

The field of the invention relates generally to reciprocating compressors, and more specifically to simulating attenuation of an impulse signal of a reciprocating compressor.

At least some known reciprocating compressors are capable of providing high pressure along with variable loading and are favored for many gas process applications in various manufacturing industries. Increased compressor reliability targets have highlighted a need for identification of problems that may be associated with such compressors, such as wear of the reciprocating drive train.

For example, the mounting of seismic transducers to a reciprocating compressor is a standard method of monitoring the health of its machine train components. The attenuation of impulse signals over a period of time is a sign that the components are beginning to wear. However, there is a problem of not being able to effectively demonstrate a change in impulse signal, generated by the mechanical components of a reciprocating compressor in a timely manner.

### BRIEF DESCRIPTION OF THE INVENTION

In one aspect, a method of simulating attenuation of an impulse signal of a reciprocating compressor is provided. The method includes providing a reciprocating compressor that includes a motor, a crank connected to the motor, a compression chamber, a reciprocating piston positioned in the compression chamber, and a connecting rod attached to the piston. The method also includes connecting the connecting rod to the crank with a first crank pin, mounting at least one transducer on the reciprocating compressor, running the compressor for a first predetermined time, measuring a first impulse signal with the at least one transducer, replacing the first crank pin with a second crank pin, the second crank pin having a diameter different than the diameter of the first crank pin, running the compressor for a second predetermined time, measuring a second impulse signal with the at least one transducer, comparing the first impulse signal to the second impulse to determine an amount of attenuation between the first and second impulse signals.

In another aspect, a reciprocating compressor demonstration apparatus is provided. The demonstration apparatus includes a compression chamber, a piston movable within said compression chamber, a crank connect to and turned by a motor, a connecting rod attached at a first end to said piston and at an opposing second end to said crank, and a first crank pin and a second crank pin. The first crank pin or the second crank pin is used to connect the connecting rod to the crank. The demonstration apparatus also includes at least one transducer positioned to detect an impulse signal.

In another aspect, a method of simulating attenuation of an impulse signal of a reciprocating compressor is provided. The compressor includes a crank connected to a motor, and a connecting rod connected to a piston at one end and the crank at an opposing end. The method includes connecting the connecting rod to the crank with a first crank pin, mounting at least one transducer on the reciprocating compressor, measuring a first impulse signal with the at least one transducer while the reciprocating compressor is running, and replacing the first crank pin with a second crank pin. The second crank pin has a diameter different than the diameter of the first crank pin. The method also includes measuring a second impulse signal with the at least one transducer while the reciprocating compressor is running, and comparing the first impulse signal to the second impulse to determine an amount of attenuation between the first and second impulse signals.

### BRIEF DESCRIPTION OF THE DRAWINGS

FIG. 1 is a schematic illustration of a reciprocating compressor demonstration apparatus with cut away portions.

FIG. 2 is an exploded illustration of the connecting rod connection to the crank shown in FIG. 1.

FIG. 3 is an exploded illustration of the connecting rod connection to the crank shown in FIG. 1 in another embodiment.

### DETAILED DESCRIPTION OF THE INVENTION

A method of simulating attenuation of an impulse signal of a reciprocating compressor and a reciprocating compressor demonstration apparatus is described below in detail. The demonstration apparatus permits a user to attenuate the impulse signal of the reciprocating compressor drivetrain by inducing radial clearance between the connecting rod crank-end bearing bushing and the crank pin. A radial clearance between the bearing bushing and the crank pin is induced by removing the crank pin and installing a different crank pin having a different diameter. The crank pin is a direct interface between the crank and the connecting rod. A larger clearance between the bearing bushing and the crank pin creates a “louder” mechanical impulse event signal. The method permits a user to effectively demonstrate a change in the impulse signal generated by the mechanical components of the reciprocating compressor in a user friendly and timely manner.

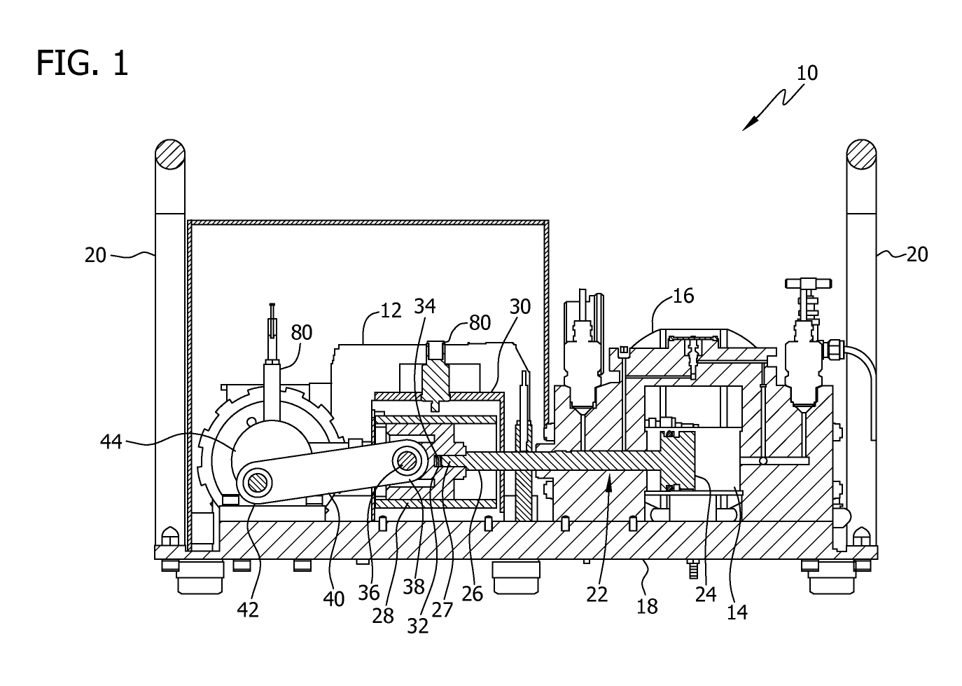

Referring to the drawings, FIG. 1 is a schematic illustration of a reciprocating compressor demonstration apparatus 10 with cut away portions. In an exemplary embodiment, reciprocating compressor demonstration apparatus 10 includes a motor 12, a compression chamber 14, and a collection chamber 16 mounted on a base 18. Apparatus 10 is compact and portable, and can include handles 20 mounted on base 18 to facilitate moving apparatus 10.

A piston 22 is positioned in compression chamber 14 and includes a piston head portion 24 and a piston rod portion 26. Piston 22 is movable in a reciprocating motion within compression chamber 14 to suction air into compression chamber 14 during an “out” stroke, and to compress the air during an “in” stroke. The distal end 27 of piston rod portion 26 is attached to a crosshead 28 positioned in a crosshead frame 30. Crosshead 28 includes a threaded cavity 32 sized to threadedly receive a threaded portion 34 of distal end 27 of piston rod portion 26. Cross head 28 is coupled to a proximate end 38 of connecting rod 40 by a crosshead pin 36. A distal end 42 of connecting rod 40 is attached to a crank 44 that is operatively coupled to a motor 12.

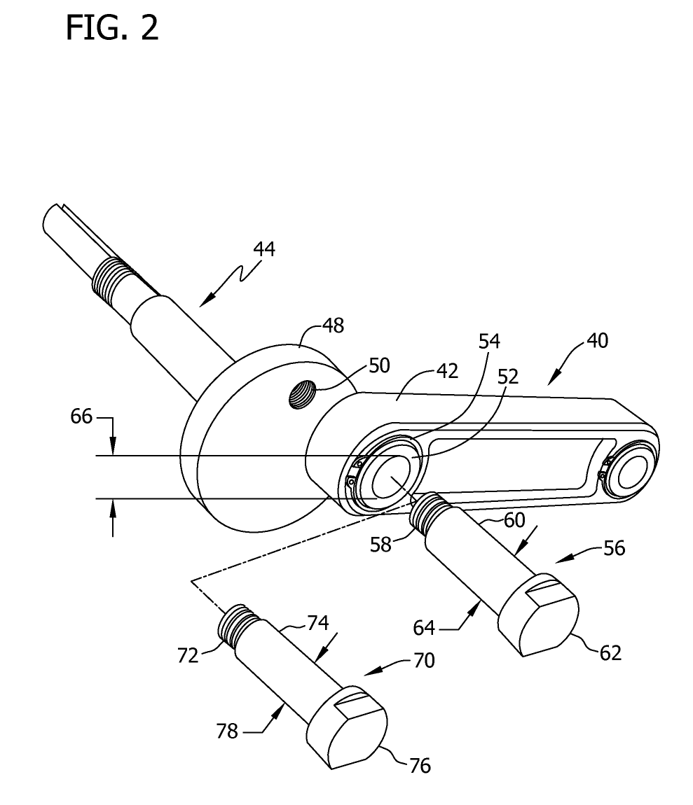

Referring also to FIG. 2, crank 44 includes a circular end portion 48 that has a threaded opening 50 positioned between the center axis and the edge of end portion 48. Distal end 42 of connecting rod 40 includes a bearing bushing 52 positioned in an opening 54. A crank pin 56 having a threaded end portion 58, a cylindrical center portion 60 and a head portion 62. Crank pin 56 is inserted through bushing 52 and end portion 58 threadedly engages threaded opening 50 of circular end portion 48 of crank 44 to connect connecting rod 40 to crank 44. The off-center position of threaded opening 50 in crank end portion 48 facilitates the reciprocating movement of piston 22 within compression chamber 14 as crank 44 rotates.

The diameter 64 of crank pin center portion 60 is approximately equal to the inside diameter 66 of bushing 52 to facilitate a minimum radial clearance between bushing 52 and the crank pin center portion 60. A second crank pin 70, similar to crank pin 56, includes a threaded end portion 72, a cylindrical center portion 74 and a head portion 76. The diameter 78 of second crank pin center portion 74 has a smaller diameter than the inside diameter 66 of bushing 52. The smaller diameter of center portion 74 creates a radial clearance between bushing 52 and crank pin center portion 74.

The radial clearance between the bearing bushing and the crank pin is induced by removing crank pin 56 and installing second crank pin 70 having a diameter 78 that is smaller than the diameter 64 of crank pin 56. The smaller diameter of second crank pin 70 creates a radial clearance between second crank pin 70 and bushing 52. When installed, crank pins 56 and 70 are a direct interface between crank 44 and connecting rod 40. A larger clearance between bushing 52 and second crank pin 70 creates a “louder” mechanical impulse event signal during the operation of reciprocating compressor demonstration apparatus 10. At least one transducer 80 is coupled to demonstration apparatus 10 to detect the impulse signal.

Reciprocating compressor demonstration apparatus 10 is used to simulate the attenuation of impulse signals as a sign that components of a reciprocating compressor are beginning to wear. To simulate the attenuation of impulse signals, connecting rod 40 is attached to circular end portion 48 of crank 44 by inserting crank pin 56 through bushing 52 and threading end portion 58 of crank pin 56 into threaded opening 50 of circular end portion 48 of crank 44. Reciprocating compressor demonstration apparatus 10 is then run and a first impulse signal is detected by transducers 80 for measurement. Then, crank pin 56 is removed and second crank pin 70 is used to attach connecting rod 40 to circular end portion 48 of crank 44. Second crank pin 70 is inserted through bushing 52 and end portion 72 of crank pin 70 is threaded into threaded opening 50 of circular end portion 48 of crank 44. Reciprocating compressor demonstration apparatus 10 is then run and a second impulse signal is detected by transducers 80 for measurement. The larger clearance between bushing 52 and second crank pin 70 simulates component wear of the crank to connecting rod juncture. Comparing the first and the second impulse signal will show that the second impulse signal is larger or “louder” than the first impulse signal which demonstrates worn compressor components.

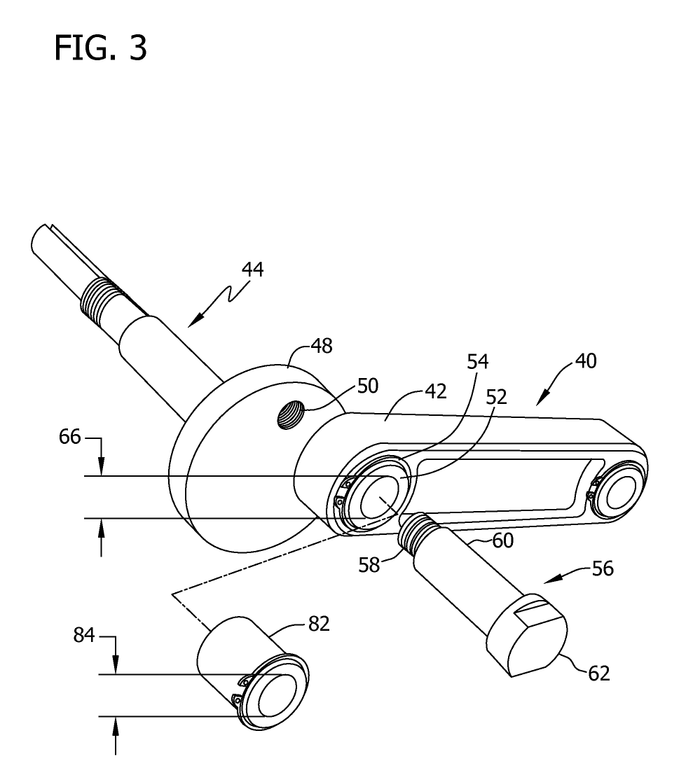

In another embodiment, shown in FIG. 3, demonstration apparatus 10 includes a second bearing bushing 82 that can be positioned in opening 54 of connecting rod 40. Second bushing 82 has an inside diameter 84 that is larger than the inside diameter 66 of bushing 52. The radial clearance between the bearing bushing and the crank pin is induced by removing bushing 52 and installing second bushing 82 having inside diameter 84 that is larger than diameter 64 of crank pin 56.

To simulate the attenuation of impulse signals, connecting rod 40 is attached to circular end portion 48 of crank 44 by inserting crank pin 56 through bushing 52 and threading end portion 58 of crank pin 56 into threaded opening 50 of circular end portion 48 of crank 44. Reciprocating compressor demonstration apparatus 10 is then run and a first impulse signal is detected by transducers 80 for measurement. Then, bushing 54 is removed and second bushing 82 is positioned in opening 54 of connecting rod 40. Crank pin 56 is inserted through bushing 82 and end portion 58 of crank pin 56 is threaded into threaded opening 50 of circular end portion 48 of crank 44. Reciprocating compressor demonstration apparatus 10 is then run and a second impulse signal is detected by transducers 80 for measurement. The larger clearance between bushing 82 and crank pin 56 simulates component wear of the crank to connecting rod juncture. Comparing the first and the second impulse signal will show that the second impulse signal is larger or “louder” than the first impulse signal which demonstrates worn compressor components. In another embodiment, bushing 52 has an adjustable inside diameter so that the impulse event signal can be affected by adjusting the inside diameter of bushing 52 to create different clearances between bushing 52 and crank pin 56.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of simulating attenuation of an impulse signal of a reciprocating compressor, said method comprising:
providing a reciprocating compressor comprising a motor, a crank connected to the motor, a compression chamber, a reciprocating piston positioned in the compression chamber, and a connecting rod attached to the piston;
connecting the connecting rod to the crank with a first crank pin;
mounting at least one transducer on the reciprocating compressor;
running the compressor for a first predetermined time;
measuring a first impulse signal with the at least one transducer;
replacing the first crank pin with a second crank pin, the second crank pin having a diameter different than the diameter of the first crank pin;
running the compressor for a second predetermined time;
measuring a second impulse signal with the at least one transducer; and
comparing the first impulse signal to the second impulse to determine an amount of attenuation between the first and second impulse signals.

2. The method in accordance with claim 1 wherein the connecting rod comprises a bushing positioned in an opening in the connecting rod, and connecting the connecting rod to the crank comprises inserting the first crank pin or the second crank pin through the bushing.

3. The method in accordance with claim 1 wherein the crank comprises a threaded opening and the first and the second crank pins comprise a threaded end, and connecting the connecting rod to the crank comprises threading the threaded end of the first crank pin or the second crank pin into the threaded opening of the crank.

4. The method in accordance with claim 2 wherein a diameter of the first crank pin is about equal to an inside diameter of the bushing, and inserting the first crank pin through the bushing comprises inserting the first crank pin through the bushing to form a first radial clearance between the bushing and the first crank pin.

5. The method in accordance with claim 4 wherein a diameter of the second crank pin is less than the inside diameter of the bushing, and inserting the second crank pin through the bushing comprises inserting the second crank pin through the bushing to form a second radial clearance between the bushing and the second crank pin, the second radial clearance greater than the first radial clearance.

6. A reciprocating compressor demonstration apparatus comprising:
a compression chamber;
a piston movable within said compression chamber;
a crank connect to and turned by a motor;
a connecting rod attached at a first end to said piston and at an opposing second end to said crank;
a first crank pin and a second crank pin, said first crank pin or said second crank pin connecting said connecting rod to said crank, said second crank pin having a diameter different than a diameter of said first crank pin; and
at least one transducer positioned to detect an impulse signal.

7. The reciprocating compressor demonstration apparatus in accordance with claim 6 wherein said connecting rod comprises a first opening located in said first end and a second opening in said second end.

8. The reciprocating compressor demonstration apparatus in accordance with claim 7 wherein said crank comprises a threaded opening, and said first crank pin and said second crank pin each comprise a threaded end, said first and second crank pins threaded ends sized to threadedly engage said threaded opening.

9. The reciprocating compressor demonstration apparatus in accordance with claim 7 wherein said connecting rod further comprises a bushing positioned in said first opening, said first crank pin or said second crank pin extending through said bushing.

10. The reciprocating compressor demonstration apparatus in accordance with claim 9 wherein a diameter of said first crank pin is about equal to an inside diameter of said bushing, and wherein said first crank pin extends through said bushing and forms a first radial clearance between said bushing and said first crank pin.

11. The reciprocating compressor demonstration apparatus in accordance with claim 10 wherein a diameter of said second crank pin is less than the inside diameter of said bushing, and wherein said second crank pin extends through said bushing and forms a second radial clearance between said bushing and said second crank pin, said second radial clearance greater than said first radial clearance.

12. The reciprocating compressor demonstration apparatus in accordance with claim 7 further comprising a first bushing and a second bushing, said first bushing or said second bushing positioned in said first control rod opening, said first crank pin extending through said first bushing or said second bushing.

13. The reciprocating compressor demonstration apparatus in accordance with claim 12 wherein said first bushing having an inside diameter that is less than the inside diameter of said second bushing, a radial clearance between said first crank pin and said first bushing is less than a radial clearance between said first crank pin and said second bushing.

14. The reciprocating compressor demonstration apparatus in accordance with claim 9 wherein said bushing comprises an adjustable inside diameter.

15. A method of simulating attenuation of an impulse signal of a reciprocating compressor, the compressor comprising a crank connected to a motor and a connecting rod connected to a piston at one end and the crank at an opposing end, said method comprising:
connecting the connecting rod to the crank with a first crank pin;
mounting at least one transducer on the reciprocating compressor;
measuring a first impulse signal with the at least one transducer while the reciprocating compressor is running;
replacing the first crank pin with a second crank pin, the second crank pin having a diameter different than the diameter of the first crank pin;
measuring a second impulse signal with the at least one transducer while the reciprocating compressor is running; and
comparing the first impulse signal to the second impulse to determine an amount of attenuation between the first and second impulse signals.

16. The method in accordance with claim 15 wherein the connecting rod comprises a bushing positioned in an opening in the connecting rod, and connecting the connecting rod to the crank comprises inserting the first crank pin or the second crank pin through the bushing.

17. The method in accordance with claim 15 wherein the crank comprises a threaded opening and the first and the second crank pins comprise a threaded end, and connecting the connecting rod to the crank comprises threading the threaded end of the first crank pin or the second crank pin into the threaded opening of the crank.

18. The method in accordance with claim 16 wherein a diameter of the first crank pin is about equal to an inside diameter of the bushing, and inserting the first crank pin through the bushing comprises inserting the first crank pin through the bushing to form a first radial clearance between the bushing and the first crank pin.

19. The method in accordance with claim 18 wherein a diameter of the second crank pin is less than the inside diameter of the bushing, and inserting the second crank pin through the bushing comprises inserting the second crank pin through the bushing to form a second radial clearance between the bushing and the second crank pin, the second radial clearance greater than the first radial clearance.

20. The method in accordance with claim 15 wherein the second crank pin is not used and said method comprises:
positioning a first bushing in an opening in the connecting rod;
inserting the first crank pin through the first bushing to connect the connecting rod to the crank;
measuring the first impulse signal with the at least one transducer while the reciprocating compressor is running;
replacing the first bushing with a second bushing, the second bushing having a larger interior diameter than an interior diameter of the first bushing;
inserting the first crank pin through the second bushing to connect the connecting rod to the crank;
measuring the second impulse signal with the at least one transducer while the reciprocating compressor is running; and
comparing the first impulse signal to the second impulse to determine an amount of attenuation between the first and second impulse signals.
